(19) United States
(12) Patent Application Publication
(10) Pub. No.: US 2008/0095464 A1
(43) Pub. Date: Apr. 24, 2008

(54) System and Method for Representing Motion Imagery Data

(75) Inventors: Kenbe D. Goertzen, Topeka, KS (US); Michael Paulson, Topeka, KS (US); Gary Hammes, Topeka, KS (US); Cary Shoup, Topeka, KS (US)

Correspondence Address: BROMBERG & SUNSTEIN LLP, 125 SUMMER STREET, BOSTON, MA, 02110-1618, US

(73) Assignee: QUVIS, INC., Topeka, KS (US)

(21) Appl. No.: 11/875,879

(22) Filed: Oct. 20, 2007

Related U.S. Application Data
(60) Provisional application No. 60/862,323, filed on Oct. 20, 2006.
(60) Provisional application No. 60/874,211, filed on Dec. 11, 2006.

(51) Int. Cl. G06K 9/36

(52) U.S. Cl. 382/278

(57) ABSTRACT

A method and system for representing stereoscopic motion imagery data having a right eye spatial data set and a left eye spatial data set. Each member of the left eye data set has a corresponding member in the right eye data set. The method determines correlated data and uncorrelated data between at least one left eye member and corresponding right eye member and compresses the correlated and the uncorrelated data. The method then forwards the compressed correlated and uncorrelated data at or below a predetermined channel capacity.

### PRIORITY

This patent application claims priority from the following provisional United States patent applications:

Application No. 60/862,323, filed Oct. 20, 2006, entitled, “Image Compression Compliant with a Pre-Determined Data Rate,” assigned attorney docket number 2418/142, and naming Kenbe D. Goertzen, Gary Hammes, and Michael Paulson as inventors, the disclosure of which is incorporated herein, in its entirety by reference.

Application No. 60,874,211, filed Dec. 11, 2006, entitled, “Improved Correlation For Encoding/Decoding in a Bandwidth Constrained Environment,” assigned attorney docket number 2418/143, and naming Kenbe D. Goertzen, Gary Hammes, and Michael Paulson as inventors, the disclosure of which is incorporated herein, in its entirety by reference.

### FIELD OF THE INVENTION

The invention generally relates to motion imagery data and, more particularly, the invention relates to systems and methods for representing motion imagery data.

### BACKGROUND ART

In the prior art, there are a number of protocols for motion video processing that require an I/O data rate limit. For example, the Digital Cinema Initiative (DCI) requires that the data rate for JPEG2000 compressed motion video is no greater than 250 Mb/s. DVD is another protocol that has an I/O data rate limit (9.3 Mb/s). As a result, if a compliant 2D DCI solution or a compliant 24 Hz DCI solution exists and a user desires to convert the digital video stream to a 3D representation or have a 48 Hz frame rate, the quality of the video is forced to decrease due to the data rate limit when prior art compression techniques are used.

Prior art solutions for providing 3D representations include using two separate servers to provide two streams of video, one for the left eye and one for the right eye wherein each runs at approximately 250 Mb/s. This solution is not DCI compliant as there are two separate streams and the overall data rate is 500 Mb/s which is in excess of the DCI recommendation. In addition, this solution requires a second server and is less attractive to theater owners due to the added expense. Other proposed solutions decrease the data rate to 125 Mb/s by sub-sampling the data for both the right and the left eye data streams in order to meet the data rate limit. Although, this solution can be DCI compliant, meeting the I/O data rate limit and fitting into a single DCI compliant stream format, the quality level of the images are greatly reduced.

### SUMMARY OF THE INVENTION

In accordance with one embodiment of the invention, a method for representing stereoscopic motion imagery data is presented. The motion imagery data may include a right eye spatial data set and a left eye spatial data set and each member of the left eye data set may have a corresponding member in the right eye data set. A member may be an image frame or an image field. The left eye data set and the right eye data set may include a plurality of images that are at least 2K resolution. The method may include determining the correlated data and the uncorrelated data between at least one left eye image frame and corresponding right eye image frame, for example, using a Haar filter. This step preprocesses the motion imagery data so as to maintain the information content while reducing redundancy prior to compression. Once the correlated and uncorrelated data is determined, the method compresses the correlated and the uncorrelated data, and forwards the compressed correlated and uncorrelated data at or below a predetermined channel capacity. For example, the predetermined channel capacity may be less than or equal to 250 Mb/s as required by the Digital Cinema Initiative. The correlated and uncorrelated data may be compressed using JPEG 2000 compression techniques and may be compresses in separate processes.

In accordance with other embodiments, the method may package the correlated and uncorrelated data into a Digital Cinema Initiative compliant package prior to forwarding the compressed correlated and uncorrelated data. The method may also apply a color transform to the left eye member and the right eye member prior to determining correlated and uncorrelated data. Applying the color transform converts the left eye member and the right eye member from a color primary mode to a color difference mode. The method may then filter the left eye member and the right eye member such that the left eye member and the right eye member have full band luminance and half band chrominances. The left eye member and the right eye member may also be shuffled together thereby creating a combined data set representative of the left eye member and the right eye member prior to determining the correlated and uncorrelated data.

In accordance with still other embodiments, the method may compress the correlated and the uncorrelated data such that it maintains a predetermined quality level. The quality level may be maintained in the compression step without requiring repeated iterations.

In accordance with further embodiments, a method may represent motion imagery data having a first image data set and a second image data set. The first image data set and the second image data set may each include data representative of an image. Additionally, the images from the first and second image data sets are to be displayed sequentially. In certain embodiments, the images may have at least 2K resolution. The method includes determining correlated data and uncorrelated data between the first image data set and the second image data set, compressing the correlated and the uncorrelated data, and forwarding the compressed correlated and uncorrelated representations at or below a predetermined channel capacity. For example, the predetermined channel capacity may be less than or equal to 250 Mb/s. The first frame member and the second frame member may include at least one image frame.

The method may compress the correlated and uncorrelated data using JPEG 2000 compression techniques, and may package the correlated and uncorrelated data into a Digital Cinema Initiative compliant package. The correlated and uncorrelated data may be compressed separately or together. The method may compress the correlated and the uncorrelated data such that it maintains a predetermined quality level. The quality level may be maintained in the compression step without requiring repeated iterations.

The method may also apply a color transform to the first image data set and the second image data set prior to determining correlated and uncorrelated data. The color transform converts the data from a color primary mode to a color difference mode. The method may also filter the data such that the first image and the second image are represented with full band luminance and half band chrominances.

In some embodiments, compressing the correlated and uncorrelated data may include maintaining a predetermined quality level, which may be maintained in a single pass compression.

The preprocessing of the image data into correlated and uncorrelated components allows for the data to be passed through a quality priority encoding system wherein a quality level may be set and the data compressed so that upon decompression and post processing, the image data will maintain the quality level over substantially all image frequencies.

### BRIEF DESCRIPTION OF THE DRAWINGS

The foregoing features of the invention will be more readily understood by reference to the following detailed description, taken with reference to the accompanying drawings, in which:

FIG. 1 is system flow diagram schematically showing an encoding process in accordance with one embodiment of the present invention;

FIG. 2 shows an exemplary Haar transform;

FIG. 3 is system flow diagram schematically showing an encoding process in accordance with an alternative embodiment of the present invention;

FIG. 4 is system flow diagram schematically showing a process for decoding files creates using the encoding process shown in FIG. 1, in accordance with one embodiment of the present invention;

FIG. 5 shows an exemplary inverse Haar transform;

FIG. 6 is system flow diagram schematically showing a process for decoding files creates using the encoding process shown in FIG. 3, in accordance with another embodiment of the present invention;

FIG. 7 is a flow chart depicting a method for representing motion imagery data, in accordance with one embodiment of the invention;

FIG. 8 is a flow chart depicting a method for representing motion imagery data, in accordance with another embodiment of the invention; and

FIG. 9 is a flow chart depicting a method for representing motion imagery data, in accordance with a third embodiment of the invention.

### DETAILED DESCRIPTION OF SPECIFIC EMBODIMENTS

Visual image quality and/or compressed data bit-rate can be improved by using a correlated image technique outlined below. This process improves efficiency in a constrained environment like that specified by the Digital Cinema Initiative (DCI). In the DCI standard, the data bit rate is capped at 250 Mbps no matter whether 2K 2D, 3D, 48 Hz or 4 k data is encoded. This presents a quality and bit-rate problem especially when multiple images (as compared to 2 k−2D) are required like in stereoscopic or 48 Hz images. For stereoscopic images, redundant information between the left eye and right are stored only once allowing for the DCI limited bit-rate of the JPEG 2000 encoded images to be allocated to the visually unique features. For 48 Hz images, this may be applied to frames in temporal sequence with a similar outcome.

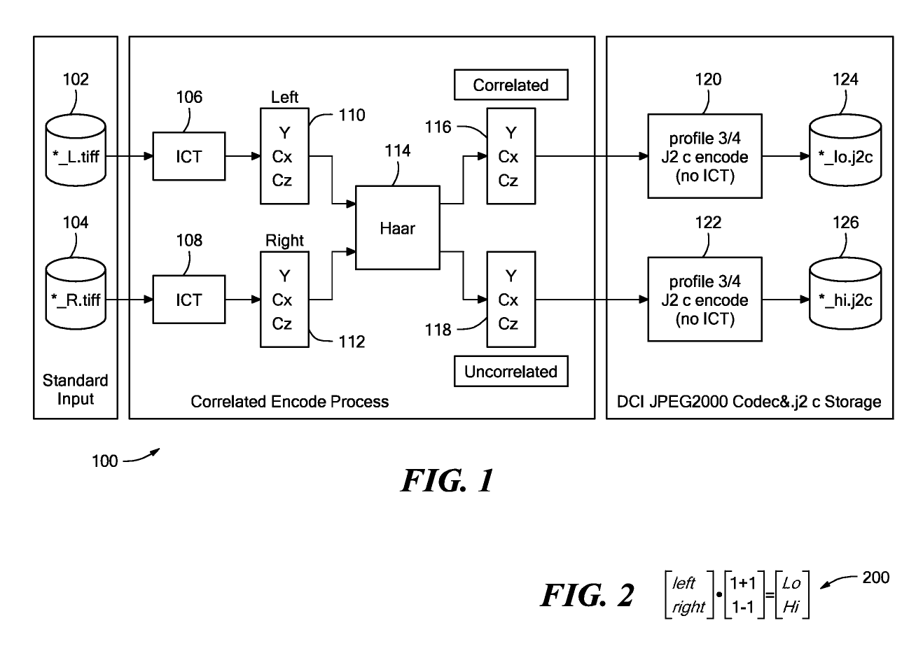

Referring to FIG. 1, a system 100 represents motion imagery data such that the overall data size of the motion data stream is reduced while maintaining quality. In many instances, the reduction in data stream size allows the motion imagery data to be compliant with an I/O data rate limit protocol, while still providing an image quality that is equivalent to that of a protocol compliant 2D representation for a 3D representation. For example, in some embodiments, the protocol is a DCI JPEG2000 recommended protocol having an I/O data rate limit of 250 Mb/s. It should be noted that, although the DCI recommendation is suggested and discussed within this application, methodologies in accordance with embodiments of the present invention may be applied to any protocol, regardless of whether or not the protocol has a data rate limit. Thus, the presently described methodology can fit a 3D representation of a motion imagery data stream having a quality level (e.g., a Signal to Noise ratio) that is compliant with the I/O data rate limit for the protocol into the same space and thus same data rate as the 2D representation having the same quality level.

As shown in FIG. 1, two standard inputs, for example, motion imagery data representing left eye data 102 and right eye data 104 may be processed using the system 100 to determine the correlated data 116 and uncorrelated data 118 between the left eye data 102 and the right eye data 104. In particular, the left eye data 102 and the right eye data may be passed through a wavelet filter 114. The wavelet filter then determines the correlated and uncorrelated data between the left eye data 102 and the right eye data 104 and outputs the correlated data 116 and the uncorrelated data 118. It is important to note that the correlated data is representative of data that is redundant between the images and the uncorrelated data is data that is not redundant between the images.

In some embodiments, the left eye data 102 and the right eye data 104 may be processed using a Haar filter (e.g., a 1-D Haar wavelet filter). The Haar filter decorrelates the left eye data stream 102 and right eye data stream 104 to determine the correlated data 116 and the uncorrelated data 118. Thus, each frame of data to be shown substantially during the same temporal period is decorrelated in total. By removing the correlated data (e.g., the redundant data) between the left eye data 102 and the right eye data 104 and creating a separate correlated data output 116, the overall data size and bit rate of the motion imagery data stream is reduced. For example, if both the left eye data 102 and the right eye data 104 are 175 Mb/s streams, but they share 100 Mb/s of correlated data, the decorrelation process will result in 250 Mb/s of data (e.g., 75 right eye uncorrelated+75 left eye uncorrelated+100 correlated=250). If the output stream is restricted to a data rate limit of 250 Mb/s (e.g., for the DCI protocol), the output data stream can then meet the data rate limit without sacrificing quality.

It is important to note that, in some embodiments, the left eye data 102 and the right eye data 104 may receive equal treatment throughout the process. The left eye data 102 and the right eye data 104 may receive equal treatment because the data may be transformed into an orthogonal space in which all of the right and left eye information is spread over the correlated and decorrelated data. In other words, the right and left eye data 102/104 are balanced and treated equally for quality purposes and there is no need to clip or otherwise reduce one set of image data and not the other.

Once the left eye data 102 and the right eye data 104 have been passed through the wavelet filter (e.g., the Haar filter 114), the resulting correlated data 116 and uncorrelated data 118 can then be compressed using standard, well-known procedures. For example, the correlated data 116 and the uncorrelated data 118 may be compressed using standard JPEG 2000 procedures. The JPEG 2000 compressor(s) 120/122 may use the parameters established in Profile 3 for 2 k digital cinema, or Profile 4 for 4 k digital cinema. The output of the compressor may be a pair of standard 3 component .j2c files 124/126. One .j2c file 124 will contain embedded correlated data for each component of the image pair. The second .j2c file 126 will contain embedded decorrelated data for each component of the image pair.

Additionally or alternatively, the correlated and uncorrelated data can be compressed using Quality Priority Encoding techniques as described in pending U.S. patent application Ser. Nos. 10/352,379 and 10/352,375 and issued U.S. Pat. No. 6,532,308 which are herein incorporated by reference in their entireties. As discussed in the above referenced applications and patent, the correlated and uncorrelated data can be encoded based upon a quality level, such as a signal to noise ratio that is guaranteed substantially over all frequencies of the image data that is either selected by a user or that is predetermined. In particular, after transform coding of image data, quality priority encoding determines a set of quantization levels based upon a sampling theory curve for the selected quality level. If a quality level is selected of n-bits, for every octave decrease below the Nyquist frequency of the image data, the quantization level is increased by 3 dB or ½ bit for every dimension in order to preserve the same signal to noise ratio as at the Nyquist frequency. As a result, data from the digital image stream (e.g., the motion imagery data) that come from lower frequency bands are quantized with more bits so as to maintain the desired resolution. For example, if the digital image stream is split into three frequency bands (low, med. and high) and the desired quality level is 12 bits the lowest frequency within the high band is determined and if it is within the first octave below Nyquist, the band is quantized with 12 bits. If the med. frequency band falls within the second octave below Nyquist, this band will be quantized with 13 bits of information (assuming that there is only spatial encoding of the image of two dimensions). If the lowest frequency band falls within five octaves below Nyquist, the band will be quantized with 16 bits. Employing quality priority encoding, a predetermined quality level is maintained over substantially all image frequencies upon decompression of the digital data.

It is important to note that the quality priority encoding discussed above compresses the image data and maintains the data at the pre-determined quality level in a single pass. In other words, the QPE systems do not use feedback to iteratively compress, decompress, measure a quality level for the images, and recompress the data until the desired quality level is maintained. Further, compression systems that include such iterative compressions use a different quality level metric wherein a signal to noise ration is determined for the image data in the spatial domain as opposed to a guaranteed quality level over substantially all frequencies as is used for QPE. Thus, QPE is able to compress the image data in a single pass, without feedback, and maintain the pre-determined quality level.

Combining the above described pre-processing steps and Quality Priority Encoding provides substantial benefits over the prior art. In particular, the decorrelation preprocessing compliments the QPE process and provides a system that maintains the information content and reduces redundancy within the starting images. In addition, the combination is also able to provide and maintain a predetermined quality level over substantially all frequencies.

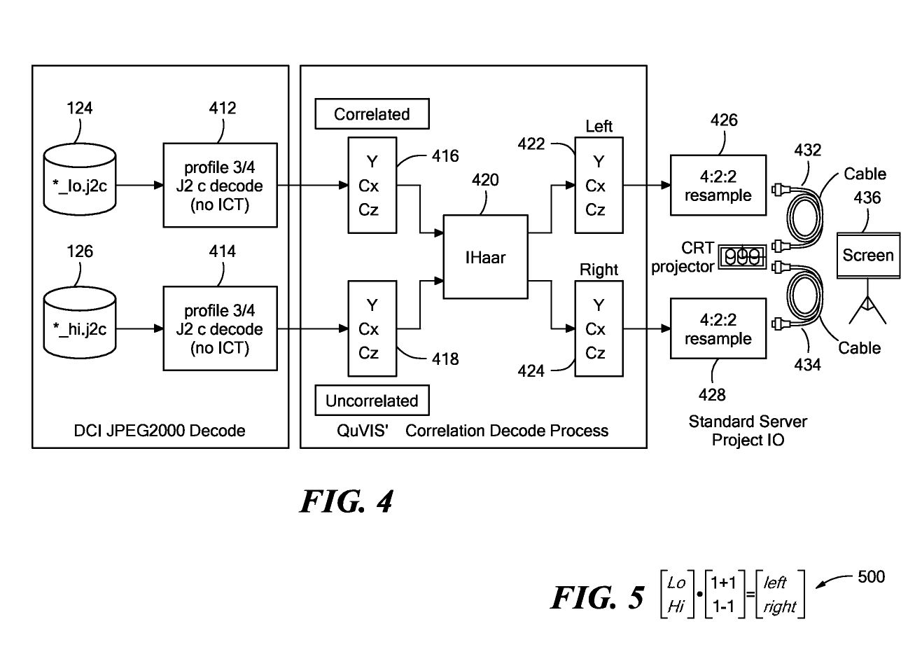

Once the correlated data 116 and the uncorrelated data 118 are compressed the system 100/300 may forward the compressed correlated data and the compressed uncorrelated data at or below a predetermined channel rate. For example, the predetermined channel rate may be a rate specified by the DCI protocol. It is important to note that the term channel rate refers to the rate at which data is passed between components in a system. For instance, a data channel can be a link between a server and a projector 430 (see FIG. 4) in a digital cinema presentation. Alternatively, the data channel may be a link between the server memory and the server processor. Channel rate refers to the rate at which the compressed data is transferred between the components.

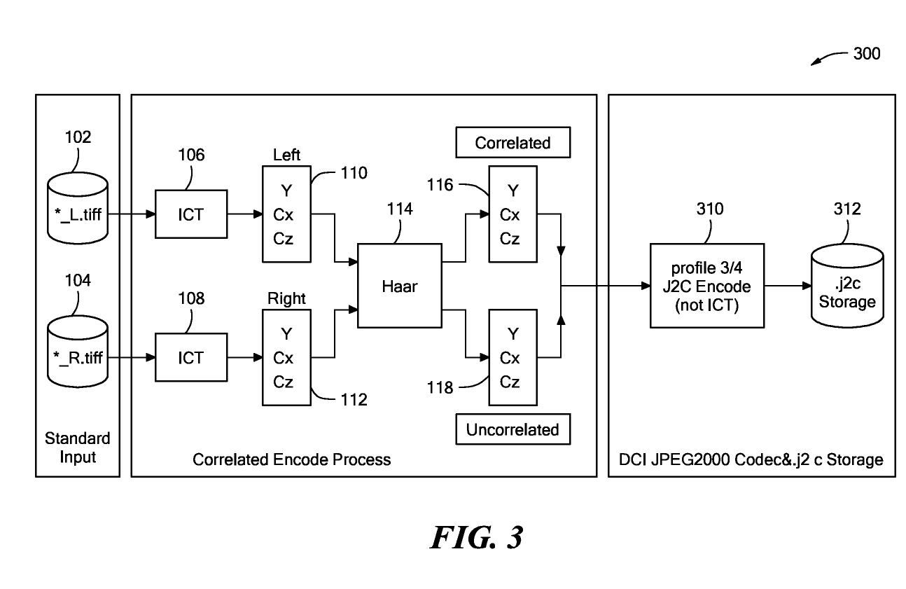

In alternative embodiments of the present invention, the correlated data 116 and the uncorrelated data 118 may be compressed together, as opposed to separately as discussed above. In particular, as shown in FIG. 3, after the correlated data 116 and the uncorrelated data 118 are outputted, the system 300 can combine the correlated data 116 and the uncorrelated data 118 into a single image file (see FIG. 3). This combined image file can then be compressed according to any of the techniques described above. For example, the combined image file can be compressed using standard JPEG 2000 procedures using JPEG compressor 310. Additionally, the combined image file can be compressed or encoded using QPE algorithms described above. Unlike embodiments in which the correlated data 116 and the uncorrelated data are compressed separately, the output of the JPEG compressor 310 may be a single 3 component .j2c files 312 with embedded correlated and decorrelated data for each component of the image pair.

Although not necessary to achieve many of the benefits of the present invention, some embodiments of the present invention may also perform additional pre-processing steps or processing steps to achieve further quality enhancement. For example, the system 100/300 may apply a color transform 106/108 to the pre-processed image streams (e.g., left eye data 102 and the right eye data 104). The color transform, for example, an irreversible color transform (ICT) converts the left eye data 102 and the right eye data 104 from color primary mode to color difference mode (e.g., X, Y, Z to Y, Cx, Cz). In addition to achieving further quality enhancements, applying the color transform also increases the compression efficiency. In some embodiments, the system 100/300 can indicate whether the color transform has been applied or not within the main header of the .j2c file by the COD marker, parameter SGCOD bits 21 to 34. The value of the SGCOD parameter is not constrained by DCI.

Additionally, the color transformed input images (e.g., the left eye 110 and the right eye 112) can be filtered prior to the Haar filter. For example, assuming the color transformed images 110/112 may be represented by a 4:4:4 ratio of luminance to chrominances, the color transformed images 110/112 may be filtered 4:2:2. The 4:2:2 ratio is consistent with the current projector 10 format for 3D being dual 4:2:2 streams. Moreover, the filtering forces the allocation of bandwidth to full band luminance and half band chrominances, which is also more consistent with then human eye's sensitivity. Although the image is filtered, it is not decimated, such that a forwards and backwards compatible 4:4:4 .j2c package may be used. This allows the image to be compatible with DCI standards which require full three band 4:4:4.

Although the above filtering is described as filtering the color transformed images 110/112 to 4:2:2 other filtering techniques can be used. For example, the color transformed images 110/112 may be filtered to 4:2:0. Additionally, each of the chrominances (e.g., Cx and Cy) can be band limited, particular when the majority of the noise is in the high frequency bands (because the human eye is not sensitive to higher frequency ranges). In addition to enhancing quality, filtering the color transformed images 110/112 in this manner also improves the decorrelation of the left eye and right eye data because it reduces the amount of noise within the images entering the Haar filter.

In accordance other embodiments, the systems 100/300 and techniques described above can be used for temporal compression that is compliant with the DCI recommendations for JPEG2000. For example, since sequential frame pairs are sent together under the same header, the two frames can be decorrelated using a Haar filter described above. In particular, the motion imagery data may have a first image data set and a second image data set as opposed to a left and right eye data set. The first image data set and the second image data set may each include data representative of an image.

In such first image data set and second image data set embodiments, the system and methods described above will apply in a similar manner. For example, the image from first image data set and the image from the second image data set may be passed through the Haar filter to generate a correlated set of data and an uncorrelated set of data. The correlated data represents the data that was redundant from the first data set image and the second data set image. The uncorrelated data represents the data that was specific to each frame. Once the correlated and uncorrelated data is determined, they can be inserted into the protocol at the locations previously taken by the first and second video frames. Thus, if the transmission rate was originally 24 frames per second, the frame rate may be increased. For example, the frame rate may be increased to 48 frames per second.

The correlated and uncorrelated data can then be compressed (e.g., by combining the data and compressing together or by compressing individually). The system 100/300 may then forward the compressed correlated and uncorrelated data at or below a predetermined channel capacity.

As shown in FIG. 4, one embodiment of the decode process starts with a pair of .j2c files 124/126 produced during the encode process described above. They are compliant with the existing DCI specification as defined by ISO/IEC 15444-1:2004/Amd.1:2006. JPEG-2000 contains profiles which describe codestream features allowable in the file. This is useful for a decoder to understand whether it will be able to decode the image file or not. Profile 3 specifies the agreed upon limitations for 2 k digital cinema while Profile 4 specifies the codestream limitations for 4 k digital cinema. The input files 124/126 are compliant to either Profile 3 or 4.

Each image file (.j2c) 124/126 may be processed by a standard JPEG 2000 decoder 412/414 which is capable of completely decoding a Profile 3 or Profile 4 compressed image. The JPEG 2000 decoder does not perform the inverse color transform as it is specified in the .j2c main header. No change from a standard compliant DCI decoder is required. The output of the decoders 412/414 is a pair of 3 component uncompressed images. One image 416 contains the correlated data of the original pair, and the second image 418 contains the uncorrelated data created during encoding by the Haar transform. If a color transform was performed during the encoding process, each image 416/418 may contain three components which are in a color difference space, Y, Cx, Cz. On a component basis, the correlated data and uncorrelated data are sent through the inverse wavelet transform, i.e. the inverse Haar transform filter (IHaar) 420 shown FIG. 4, IHaar. This reconstructs the left and right images (or the first data set image and second data set image) from the correlated and uncorrelated data. The equation for the inverse transform is shown in FIG. 5. The unity tap values in the matrix can be scaled for normalization if desired.

The outcome is left and right image pairs each in color difference space, i.e. Y, Cx, Cz. If a full 4:4:4 image is decoded and a 4:2:2 image is required for output over SDI links then a low pass filter 426/428 may be applied before decimation and then output over the SDI links 432/434 to the projector 430. This downsampling/decimation process may not be required in various servers as the image is partially decoded to a 4:2:2 sample space by not including the horizontal high pass data from the 5^{th} band wavelet. If display on a color primary device is required, the 4:4:4 output image should be sent through the inverse ICT process. It should be recognized by those of ordinary skill in the art that, although JPEG 2000 is specifically called out as the compression process, other compression processes may also work with the present invention. Similarly, the specification references the DCI standard, although the present invention is compatible with other bandwidth constrained protocols. Further, the specification references a Haar transform, although other transforms may be used that divide a signal into multiple components i.e. high and low frequencies.

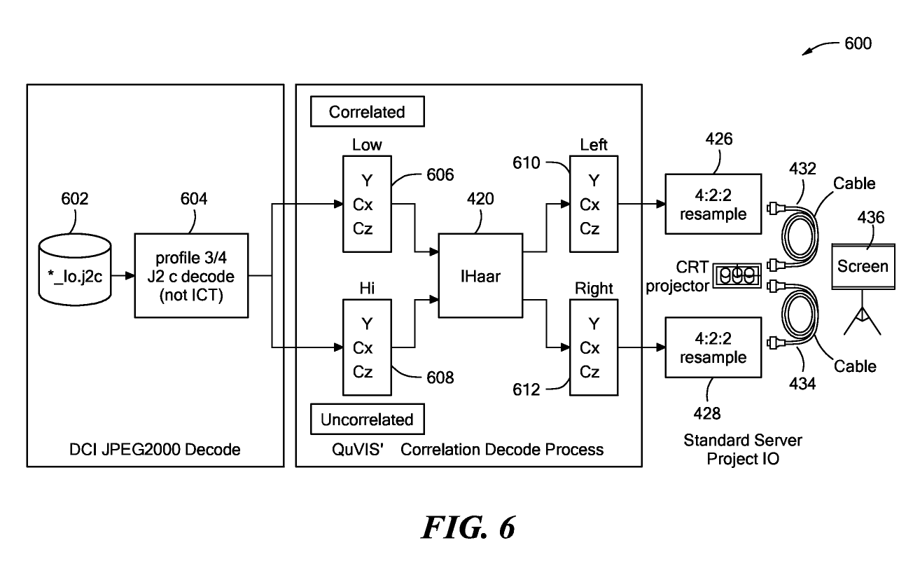

In alternative embodiments of the decode process in which the correlated data and the uncorrelated data were combined prior to compressing, the decode process will start with a single .j2c file 602 produced during the encode process described above, FIG. 6. The image file (.j2c) 602 may be processed in a manner similar to the two image decoding described above. However, unlike the two image decoding, once the single image file 602 is decoded using the decoder 604, the decoded image is split into two separate image files—the correlated data 606 and the uncorrelated data 608. On a component basis, the correlated data and uncorrelated data are sent through the inverse wavelet transform, i.e. the inverse Haar transform filter (IHaar) 420 shown FIG. 6, IHaar. This reconstructs the left and right images 610/612 (or the first data set image and second data set image) from the correlated and uncorrelated data. The remaining processing is identical to that described above with respect to FIG. 4. It is important to note that, regardless of whether the decoding process starts with a single image, as shown in FIG. 6, or two images as shown in FIG. 5, the encoding/decoding process described above, surprisingly, resulted in the same amount of information within the processed image as the original image. Additionally, the final processed image did not contain any artifacts from the filtering process described above.

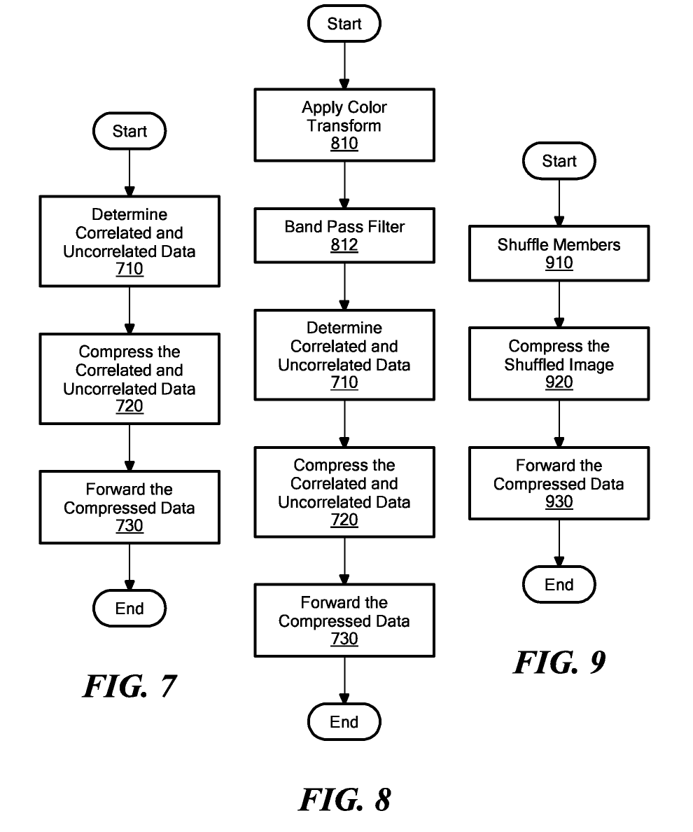

FIG. 7 shows a method for representing motion imagery data, in accordance with embodiments of the invention. In particular, the method first determines the correlated and uncorrelated data for the images to be processed (Step 710). For example, if the motion data is stereoscopic motion imagery data, the method will determine the correlated and uncorrelated data of the left eye member and the right eye member, as described above. It should be noted that the term member can include an image, a frame, image fields, or even individual pixels. Alternatively, if the motion data is temporal in nature, the method will determine the correlated and uncorrelated data of the first data set image and the second data set image (e.g., the sequential frames). Once the correlated and uncorrelated data is determined, the method compresses the correlated data and the uncorrelated date (Step 720). As mentioned above, the data can be compressed separately or the data may be combined and compressed together as a single data set. Once the data is compressed, the method then forwards the compressed data (Step 720) at or below a predetermined channel capacity.

As shown in FIG. 8, some embodiments of the present invention have additional pre-processing steps that enhance the image quality and improve compression efficiency. For example, as described above, the method may apply a color transform to the starting images (e.g., the left eye member and the right eye member) in order to convert the image from a color primary mode to a color difference mode (Step 810). The method may then also perform a band pass filter (Step 812) on the color transformed images to reduce the redundant information within the luminance and chrominance bands, as described above.

In accordance with other embodiments of the present invention, the starting images (e.g., the left eye member and the right eye member or the first data set image and the second data set image) may be shuffled together to create a single master image. For example, if the two first starting images are both 2K×2K, then the combined master image will be 2K×4K (2K×2K+2K×2K). In particular, shuffling the images together includes inclusion of all of the information of the first image and all of the information from the second image. The information may be combined in a number of ways including, but not limited to a column by column basis, a row by row basis, or a pixel be pixel basis. In other words, if the starting images are shuffled on a row by row basis, row 0 of the master image will be row 0 of the first image, row 1 of the master image will be row 0 of the second image, row 2 of the master image will be row 1 of the first image, row 3 of the master image will be row 1 of the second image and so on. Therefore, the final master image will be an inter-mingled combination of the data from the first image and the second image.

Once the master image is created, the master image may be processed with any number of wavelet based filters to encode and compress the master image. Moreover, because the master image is a single image, the wavelet based transform may include a sophisticated wavelet. For example, the master image may be processed using a 9 tap filter to transform the master image into multiple sub-bands.

As mentioned above, one benefit of using the shuffling method is that a more sophisticated wavelet may be used. More sophisticated wavelets, for example the 9 tap filter described above, allow the system to get a larger frequency response. Additionally, the 9 tap filter allows the system to optimize both the locality and the frequency specificity, thereby improving the quality of the resulting image and the overall system efficiency.

FIG. 9 shows a method of processing two starting images using the shuffling approach described above. In particular, the method first shuffles the starting images (Step 910) (e.g., the left eye member and the right eye member or the first data set image and the second data set image). As discussed above, shuffling the two starting images creates a single master image with combined information from the starting images. The method may then compress the master image using a wavelet filter (Step 930). In previous embodiments, the Haar filter was preferred because of its lossless nature. In the present embodiment, a more sophisticated wavelet may be used (e.g., a 9 tap filter) to optimize the locality and frequency specificity. Once the master image is compressed, the method may then forward the compressed data (Step 930), for example, at or below a predetermined channel capacity.

In an alternative embodiment, part of the disclosed invention may be implemented as a computer program product for use with the electronic circuit and a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Further the digital data stream may be stored and maintained on a computer readable medium and the digital data stream may be transmitted and maintained on a carrier wave.

The described embodiments of the invention are intended to be merely exemplary and numerous variations and modifications are intended to be within the scope of the present invention as described herein and as defined in any appended claims. It should be recognized by one of ordinary skill in the art that the described methodology may be embodied as a computer program product for use with a computer wherein the computer program product contains computer readable code thereon. In addition, the methodology may be embodied as logic, such as electronic circuitry or as firmware that is a combination of electronic circuitry and computer readable code stored in a memory location.

What is claimed is:

1. A method for representing stereoscopic motion imagery data having a right eye spatial data set and a left eye spatial data set wherein each member of the left eye data set has a corresponding member in the right eye data set, the method comprising:
determining correlated data and uncorrelated data between at least one left eye member and corresponding right eye member;
compressing the correlated and the uncorrelated data; and
forwarding the compressed correlated and uncorrelated data at or below a predetermined channel capacity.

2. A method according to claim 1, wherein the predetermined channel capacity is less than or equal to 250 Mb/s.

3. A method according to claim 2, wherein compressing the correlated and uncorrelated data includes compressing the correlated and uncorrelated data using JPEG 2000 compression techniques.

4. A method according to claim 2, wherein the left eye each of the left eye spatial data set and the right eye spatial data set include a plurality of images that are at least 2K resolution.

5. A method according to claim 1, wherein the correlated and uncorrelated data are compressed separately.

6. A method according to claim 1, further comprising applying a color transform to the left eye member and the right eye member prior to determining correlated and uncorrelated data, wherein applying the color transform converts the left eye member and the right eye member from a color primary mode to a color difference mode and wherein the left eye member and the right eye member include at least one image frame.

7. A method according to claim 6, the method further comprising filtering the left eye member and the right eye member such that the left eye member and the right eye member have full band luminance and half band chrominances.

8. A method according to claim 1, wherein the correlated and uncorrelated data is determined using a Haar filter.

9. A method according to claim 1, wherein compressing the correlated and uncorrelated data includes maintaining a predetermined quality level.

10. A method according to claim 9, wherein the quality level is maintained in the compression step without requiring repeated iterations.

11. A method according to claim 1 wherein prior to forwarding, packaging the correlated and uncorrelated data into a Digital Cinema Initiative compliant package.

12. A method for representing motion imagery data having a first image data set and a second image data set and wherein the first image data set and the second image data set may each include data representative of an image, the method comprising:
determining correlated data and uncorrelated data between at least one first image data set and corresponding second image data set;
compressing the correlated and the uncorrelated data; and
forwarding the compressed correlated and uncorrelated representations at or below a predetermined channel capacity.

13. A method according to claim 12, wherein the predetermined channel capacity is less than or equal to 250 Mb/s.

14. A method according to claim 13, wherein compressing the correlated and uncorrelated data includes compressing the correlated and uncorrelated data using JPEG 2000 compression techniques.

15. A method according to claim 13, wherein the left eye each of the first frame spatial data set and the second frame spatial data set include a plurality of images that are at least 2K resolution.

16. A method according to claim 12, wherein the correlated and uncorrelated data are compressed separately.

17. A method according to claim 12, further comprising applying a color transform to the first image data set and the second image data set prior to determining correlated and uncorrelated data, wherein applying the color transform converts the first image data set and the second image data set from a color primary mode to a color difference mode and wherein the first image data set and the second image data set include at least one image frame.

18. A method according to claim 17, the method further comprising filtering the first frame member and the second frame member such that the first frame member and the second frame member have full band luminance and half band chrominances.

19. A method according to claim 12, wherein the correlated and uncorrelated data is determined using a Haar filter.

20. A method according to claim 12, wherein compressing the correlated and uncorrelated data includes maintaining a predetermined quality level.

21. A method according to claim 12, wherein the predetermined quality level is maintained in the compression step without requiring repeated iterations.

22. A method according to claim 12, wherein prior to forwarding, packaging the correlated and uncorrelated data into a Digital Cinema Initiative compliant package.
